(19) United States
(12) Patent Application Publication
(10) Pub. No.: US 2025/0205740 A1
(43) Pub. Date: Jun. 26, 2025

(54) ULTRASONIC COMPONENT PACKAGING STRUCTURE AND ULTRASONIC MODULE APPLYING SAME

(71) Applicant: SonicMEMS (ZhengZhou) Technology Co.,Ltd., Zhengzhou (CN)

(72) Inventors: Yi-Hsiang Chiu, Zhengzhou (CN); Rei Jinchi, Zhengzhou (CN); Hsien-Tsong Chen, Zhengzhou (CN); Han-Han Xie, Zhengzhou (CN)

(21) Appl. No.: 18/610,710

(22) Filed: Mar. 20, 2024

(30) Foreign Application Priority Data
Dec. 26, 2023 (TW) 112150880

(51) Int. Cl. B06B 1/06

(52) U.S. Cl. CPC B06B 1/0651; B06B 1/0622

(57) ABSTRACT

An ultrasonic component packaging structure includes a substrate, an ultrasonic component, a first pin, a second pin, and a protective shell. The substrate includes a first connection pad and a second connection pad. The ultrasonic component includes a first electrode and a second electrode that are electrically connected to the first connection pad and the second connection pad respectively. The first pin and the second pin are electrically connected to the first connection pad and the second connection pad respectively, and extend in an opposite direction of the ultrasonic component. The protective shell surrounds the substrate and the ultrasonic component, and is provided with a first opening to expose the ultrasonic component. Based on the design of the pins, the ultrasonic component can be fixed in a plugging manner, so that interference between ultrasonic components can be avoided, and a sensing distance can be effectively shortened.

### CROSS-REFERENCE TO RELATED APPLICATION

This non-provisional application claims priority under 35 U.S.C. § 119 (a) to patent application No. 112150880 filed in Taiwan, R.O.C. on Dec. 26, 2023, the entire contents of which are hereby incorporated by reference.

### BACKGROUND

### Technical Field

The present invention relates to the field of sensing, and in particular, to an ultrasonic component packaging structure and an ultrasonic module applying the same.

### Related Art

An ultrasonic module usually includes a pair of an ultrasonic transmission assembly and an ultrasonic receiving assembly, which are used to transmit an ultrasonic signal and receive a reflected wave. With continuous breakthroughs of existing technologies, the ultrasonic module can be attached to a circuit board in a flat and light manner.

The ultrasonic module performs sensing in a long distance in the past. Currently, there is also a demand for short-distance sensing. However, for a planar ultrasonic module, there is still a problem of insensitivity in a sensing distance less than ten centimeters.

### SUMMARY

To resolve the problem in the related art, an ultrasonic component packaging structure is provided. In some embodiments, the ultrasonic component packaging structure includes a substrate, an ultrasonic component, a first pin, a second pin, and a protective shell.

The substrate includes a first connection pad and a second connection pad. The ultrasonic component is arranged on a first plane of the substrate and includes a first electrode and a second electrode. The first electrode and the second electrode are electrically connected to the first connection pad and the second connection pad respectively. The first pin is electrically connected to the first connection pad and extends toward a second plane of the substrate, where the second plane is opposite to the first plane. The second pin is electrically connected to the second connection pad and extends toward the second plane of the substrate. The second pin is substantially parallel to the first pin. The protective shell surrounds the substrate and the ultrasonic component, and is provided with a first opening to expose the ultrasonic component.

In some embodiments, the first electrode and the second electrode are respectively connected to the first connection pad and the second connection pad through a connection cable.

In some embodiments, the protective shell is further provided with two second openings, where the first pin and the second pin respectively extend through the two second openings and protrude from the protective shell.

In some embodiments, the ultrasonic component includes one or more ultrasonic units. More specifically, in some embodiments, the ultrasonic unit is an ultrasonic transmitter or an ultrasonic receiver.

In some embodiments, the protective shell is made of a metal material.

In this case, an ultrasonic module is further provided. In some embodiments, the ultrasonic module includes two ultrasonic apparatuses and a circuit board, and each ultrasonic apparatus includes a substrate, an ultrasonic component, a first pin, a second pin, and a protective shell.

The substrate includes a first connection pad and a second connection pad. The ultrasonic component is arranged on a first plane of the substrate and includes a first electrode and a second electrode. The first electrode and the second electrode are electrically connected to the first connection pad and the second connection pad respectively. The first pin is electrically connected to the first connection pad and extends toward a second plane of the substrate, where the second plane is opposite to the first plane. The second pin is electrically connected to the second connection pad and extends toward the second plane of the substrate. The second pin is substantially parallel to the first pin. The protective shell surrounds the substrate and the ultrasonic component, and is provided with a first opening to expose the ultrasonic component. In the ultrasonic components of the two ultrasonic apparatuses, one is an ultrasonic transmission assembly, and the other is an ultrasonic receiving assembly. The first pins and the second pins of the two ultrasonic apparatuses are welded to the circuit board.

In some embodiments, the first electrode and the second electrode are respectively connected to the first connection pad and the second connection pad through a connection cable.

In some embodiments, the protective shell is further provided with two second openings, where the first pin and the second pin respectively extend through the two second openings and protrude from the protective shell.

In some embodiments, the ultrasonic component includes one or more ultrasonic units. More specifically, in some embodiments, the ultrasonic unit is an ultrasonic transmitter or an ultrasonic receiver.

In some embodiments, the protective shell is made of a metal material.

As described in the foregoing embodiments, the ultrasonic component is packaged in a form of a passive component or a conventional LED, and is plugged through the first pin and the second pin, to avoid direct contact with the circuit board. In this way, vibration of the circuit board caused by an ultrasonic signal or a reflected wave may be reduced, problems faced by a flat structure may be alleviated, a sensing distance is effectively shortened, and sensitivity of short-distance sensing is improved.

### BRIEF DESCRIPTION OF THE DRAWINGS

FIG. 1 is an exploded view of an embodiment of an ultrasonic component packaging structure;

FIG. 2 is a three-dimensional view of an embodiment of an ultrasonic component packaging structure;

FIG. 3 is a bottom view of an embodiment of an ultrasonic component packaging structure;

FIG. 4 is an enlarged top view of a first embodiment of an ultrasonic component;

FIG. 5 is an enlarged top view of a second embodiment of an ultrasonic component; and

FIG. 6 is a three-dimensional view of an embodiment of an ultrasonic module.

### DETAILED DESCRIPTION

It is to be understood that, when a component is referred to as being “arranged” on another component, it indicates that the component may be directly located on the another component, or there may be an intervening component, so that the component is connected to the another component through the intervening component. In contrast, when a component is referred to as being “directly arranged on another component” or “directly arranged to another component”, it may be understood that there is no intervening component in this case.

In addition, the terms such as “first”, “second”, and “third” are only used for distinguishing one component, element, region, layer, or part from another component, element, region, layer, or part, and are not intended to indicate necessary sequences. In addition, relative terms such as “below” and “upper” are used in this specification to describe a relationship between one component and another component. It should be understood that such relative terms are intended to encompass different orientations of the device in addition to the orientation depicted in the figures. For example, if the device in the figures is turned over, a component described as being “below” relative to another element may be “upper” relative to the another element. This only indicates a relative orientation relationship rather than an absolute orientation relationship.

The inventor found through experiments that, when a planar ultrasonic module performs sensing in a short distance, a circuit board is prone to generating resonance due to an ultrasonic signal from an ultrasonic transmission assembly or vibrating due to a reflected wave of an ultrasonic signal. As a result, a receiving end of the ultrasonic module is likely to be driven due to vibration from the circuit board and then stops receiving a signal. This phenomenon is more obvious when ultrasonic sensing signals are emitted intensively, causing insensitivity in short-distance sensing.

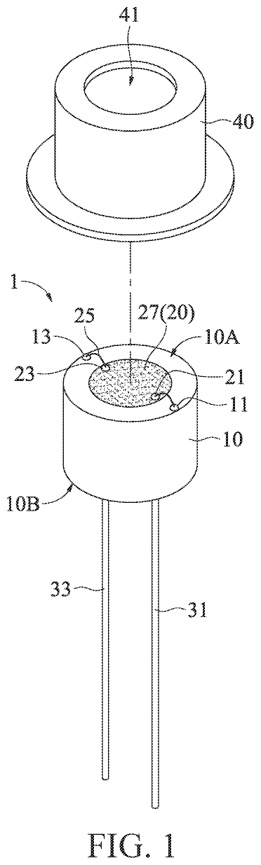

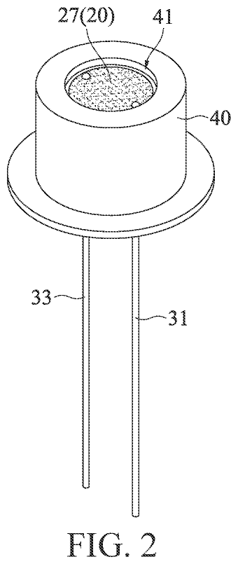

FIG. 1 is an exploded view of an embodiment of an ultrasonic component packaging structure. FIG. 2 is a three-dimensional view of an embodiment of an ultrasonic component packaging structure. As shown in FIG. 1 and FIG. 2, in some embodiments, an ultrasonic component packaging structure 1 includes a substrate 10, an ultrasonic component 20, a first pin 31, a second pin 33, and a protective shell 40.

The substrate 10 includes a first connection pad 11 and a second connection pad 13. The ultrasonic component 20 is arranged on a first plane 10A of the substrate 10 and includes a first electrode 21 and a second electrode 23. The first electrode 21 and the second electrode 23 are electrically connected to the first connection pad 11 and the second connection pad 13 respectively. In some embodiments, the first connection pad 11 and the second connection pad 13 may be bonding pads, and the first electrode 21 and the second electrode 23 are respectively connected to the first connection pad 11 and the second connection pad 13 through a connection cable 25. However, actually, the substrate 10 may alternatively be a circuit substrate, and an electrical connection is achieved through a circuit layout. Further, the connection cable 25 may be bonded to the first connection pad 11/second connection pad 13 by using an optical clear adhesive or a thermosetting adhesive.

The first pin 31 is electrically connected to the first connection pad 11 and extends toward a second plane 10B of the substrate 10, where the second plane 10B is opposite to the first plane 10A. The second pin 33 is electrically connected to the second connection pad 13 and extends toward the second plane 10B of the substrate 10. The second pin 33 is substantially parallel to the first pin 31. In other words, the first pin 31 and the second pin 33 are needle-like pins, extend in an opposite direction of the ultrasonic component 20, and are electrically connected to the ultrasonic component 20. The first pin 31 and the second pin 33 are connected to the first connection pad 11 and the second connection pad 13 by drilling holes in the substrate 10, so that connection is achieved through a circuit layout.

The protective shell 40 surrounds the substrate 10 and the ultrasonic component 20, and is provided with a first opening 41 to expose the ultrasonic component 20. The protective shell 40 may be made of a metal material, and surrounds around side edges of the substrate 10 and the ultrasonic component 20 for electromagnetic shielding, to prevent external electromagnetic interference. The ultrasonic component 20 is exposed only through the first opening 41, to further limit a pointing range of the ultrasonic component 20.

FIG. 3 is a bottom view of an embodiment of an ultrasonic component packaging structure. As shown in FIG. 3, in some embodiments, the protective shell 40 may also completely cover the substrate 10, and is provided with two second openings 45, where the first pin 31 and the second pin 33 respectively extend through the two second openings 45 and protrude from the protective shell 40.

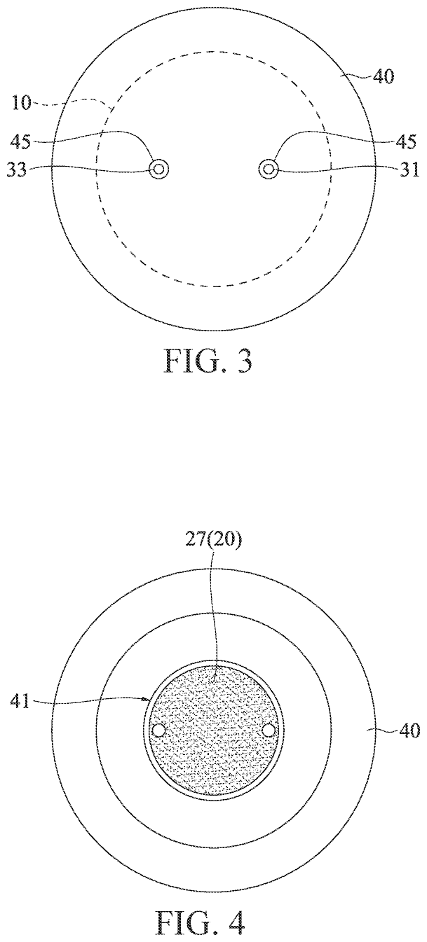

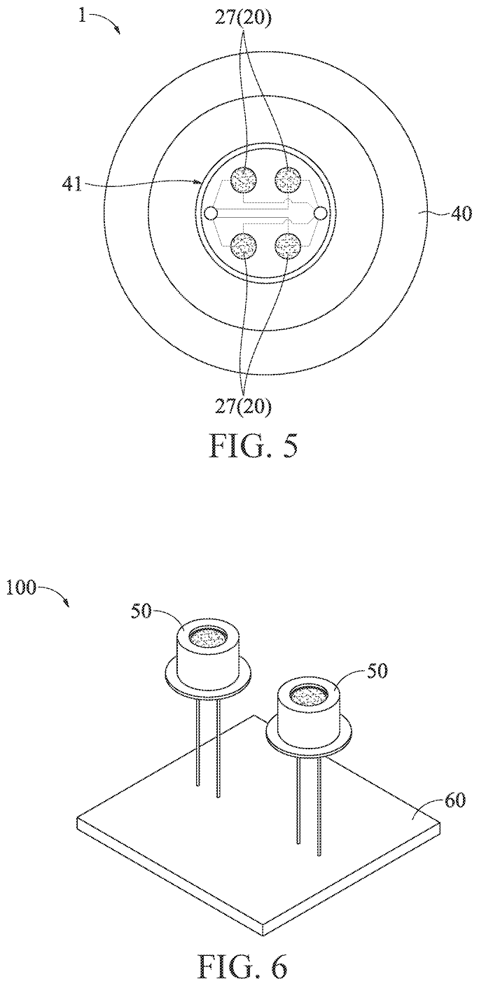

FIG. 4 is an enlarged top view of a first embodiment of an ultrasonic component. FIG. 5 is an enlarged top view of a second embodiment of an ultrasonic component. As shown in FIG. 4, the ultrasonic component 20 includes an ultrasonic unit 27. However, as shown in FIG. 5, the ultrasonic component 20 includes a plurality of ultrasonic units 27 connected in series. In this case, a quantity of ultrasonic units 27 may be adjusted according to a distance actually required to be measured and specifications such as power of the ultrasonic units 27.

In this case, the ultrasonic unit 27 is an ultrasonic transmitter or an ultrasonic receiver, and may be achieved through a piezoelectric micro-machined ultrasonic transducer (PMUT).

FIG. 6 is a three-dimensional view of an embodiment of an ultrasonic module. As shown in FIG. 6, an ultrasonic module 100 includes two ultrasonic apparatuses 50 and a circuit board 60. Each ultrasonic apparatus 50 is essentially the foregoing ultrasonic component packaging structure 1 and is configured in pairs. In ultrasonic components 20 of the two ultrasonic apparatuses 50, one is an ultrasonic transmission assembly, and the other is an ultrasonic receiving assembly. The first pins 31 and the second pins 33 of the two ultrasonic apparatuses 50 are welded to the circuit board 60.

Based on the above, the ultrasonic component 20 is packaged in a form of a passive component or a conventional LED, and is plugged through the first pin 31 and the second pin 33, to avoid direct contact with the circuit board 60. In this way, vibration of the circuit board 60 caused by an ultrasonic signal or a reflected wave may be reduced, problems faced by a flat structure may be alleviated, a sensing distance is effectively shortened, and sensitivity of short-distance sensing is improved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An ultrasonic component packaging structure, comprising:
a substrate comprising a first connection pad and a second connection pad;
an ultrasonic component arranged on a first plane of the substrate and comprising a first electrode and a second electrode, wherein the first electrode and the second electrode are electrically connected to the first connection pad and the second connection pad respectively;
a first pin electrically connected to the first connection pad and extending toward a second plane of the substrate, where the second plane is opposite to the first plane;
a second pin, electrically connected to the second connection pad and extending toward the second plane of the substrate, where the second pin is substantially parallel to the first pin; and
a protective shell, surrounding the substrate and the ultrasonic component, and provided with a first opening to expose the ultrasonic component.

2. The ultrasonic component packaging structure according to claim 1, wherein the first electrode and the second electrode are respectively connected to the first connection pad and the second connection pad through a connection cable.

3. The ultrasonic component packaging structure according to claim 1, wherein the protective shell is further provided with two second openings, wherein the first pin and the second pin respectively extend through the two second openings and protrude from the protective shell.

4. The ultrasonic component packaging structure according to claim 1, wherein the ultrasonic component comprises one or more ultrasonic units.

5. The ultrasonic component packaging structure according to claim 4, wherein the ultrasonic unit is an ultrasonic transmitter or an ultrasonic receiver.

6. The ultrasonic component packaging structure according to claim 1, wherein the protective shell is made of a metal material.

7. An ultrasonic module, comprising:
two ultrasonic apparatuses, wherein each of the two ultrasonic apparatuses comprises:
a substrate comprising a first connection pad and a second connection pad;
an ultrasonic component arranged on a first plane of the substrate and comprising a first electrode and a second electrode, wherein the first electrode and the second electrode are electrically connected to the first connection pad and the second connection pad respectively;
a first pin electrically connected to the first connection pad and extending toward a second plane of the substrate, where the second plane is opposite to the first plane;
a second pin electrically connected to the second connection pad and extending toward the second plane of the substrate, where the second pin is substantially parallel to the first pin; and
a protective shell surrounding the substrate and the ultrasonic component, and provided with a first opening to expose the ultrasonic component, wherein
in the ultrasonic components of the two ultrasonic apparatuses, one is an ultrasonic transmission assembly, and the other is an ultrasonic receiving assembly; and
a circuit board, wherein the first pins and the second pins of the two ultrasonic apparatuses are welded to the circuit board.

8. The ultrasonic module according to claim 7, wherein the first electrode and the second electrode are respectively connected to the first connection pad and the second connection pad through a connection cable.

9. The ultrasonic module according to claim 7, wherein the protective shell is further provided with two second openings, wherein the first pin and the second pin respectively extend through the second openings and protrude from the protective shell.

10. The ultrasonic module according to claim 7, wherein the ultrasonic component comprises one or more ultrasonic units.

11. The ultrasonic module according to claim 7, wherein the protective shell is made of a metal material.
